(19) United States
(12) Patent Application Publication
(10) Pub. No.: US 2026/0025718 A1
(43) Pub. Date: Jan. 22, 2026

(54) METHOD AND APPARATUS FOR DUAL CONNECTIVITY CONDITIONAL HANDOVER RECOVERY

(71) Applicant: Nokia Technologies Oy, Espoo (FI)

(72) Inventors: Umur KARABULUT, Munich (DE); Ahmad AWADA, Munich (DE); Srinivasan SELVAGANAPATHY, Bangalore (IN); Amaanat ALI, Espoo (FI); Panagiotis SPAPIS, Munich (DE); Halit Murat GÜRSU, Munich (DE)

(21) Appl. No.: 18/997,161

(22) PCT Filed: Jun. 13, 2023
(86) PCT No.: PCT/EP2023/065738

§ 371 Date: Jan. 20, 2025

(30) Foreign Application Priority Data
Aug. 2, 2022 (FI) 202241044243

(51) Int. Cl. H04W 36/00; H04W 36/36

(52) U.S. Cl. CPC H04W 36/0079; H04W 36/0069; H04W 36/362

(57) ABSTRACT

Methods and apparatuses of dual connectivity conditional handover recovery are presented. A user equipment supporting dual connectivity and configured for conditional handover, CHO, is presented that is configured to establish a connection towards a primary cell of the source master node and a primary secondary cell of the source secondary node. The user equipment is further configured to receive a plurality of CHO, to receive assistance information for CHO recovery and to determine a primary cell of a target master node and an associated CHO configuration from the plurality of CHO configurations based on the assistance information for CHO recovery. Finally, the user equipment is configured to perform CHO recovery towards the primary cell of the target master node based on the determined associated CHO configuration. Methods, network nodes and functional units of the network nodes involved in the presented dual connectivity conditional handover recovery processes are presented, too.

### THECHNICAL FIELD

The subject disclosure generally relates to wireless communication systems and, in particular, to conditional handover in wireless communication systems. Yet more particularly, the subject disclosure provides methods and apparatuses of dual connectivity conditional handover recovery.

### BACKGROUND

Wireless telecommunication systems are under constant development. There is a need for higher data rates and high quality of service. Reliability requirements are constantly rising and ways and means to ensure reliable connections and data traffic while keeping transmission delays minimal are constantly under development.

Developing networks enable new services to customers. One service is dual connectivity, in which a user equipment is connected with a master node base station and a secondary node base station for communication. Dual connectivity improves the data throughput and mobility robustness. Another service is conditional handover that further improves the mobility robustness. For conditional handover, the network may prepare multiple target cells, for which conditional handover configurations are associated with execution conditions evaluated by user equipments. These configurations can also be used for recovery and re-establishment of connections in case of radio link failures.

The use of dual connectivity and conditional handover may require advanced techniques for dual connectivity conditional handover recovery.

### SUMMARY

According to a first aspect of the subject disclosure, a user equipment (UE) configured to support operating in dual connectivity with a primary cell of a source master node of a radio access network and a primary secondary cell of a source secondary node and configured to support conditional handover, CHO, is presented. The user equipment comprises at least one processor and at least one memory including computer program code causing the user equipment, when executed with the at least one processor, to perform the processed described herein. In particular, the UE is caused to establish a connection towards a primary cell of the source master node and to establish a connection towards a primary secondary cell of the source secondary node. Moreover, the UE is caused to receive a plurality of CHO configurations from the source master node including configurations for conditional handover towards at least one target master node and at least one target secondary node and to receive assistance information for CHO recovery from the source master node. In response to the user equipment experiencing radio link failure on the primary cell of the source master node or handover failure towards a primary cell of a first target master node, the UE is caused to determine a primary cell of a second target master node and an associated CHO configuration from the plurality of CHO configurations based on the assistance information for CHO recover. Additionally, the UE is caused to perform CHO recovery towards the primary cell of the second target master node based on the determined associated CHO configuration.

In embodiments, the UE is further caused to, in response to the determined CHO configuration being a dual connectivity CHO configuration with a primary secondary cell of a target secondary node being different to a primary secondary cell of the source secondary node, perform CHO recovery towards the primary secondary cell of the target secondary node.

In some embodiments, the assistance information comprises a single-dual connectivity prioritization flag for prioritizing single or dual connectivity for CHO recovery. In further embodiments, the assistance information comprises information on pending traffic volumes on secondary cell group bearers, wherein determining the CHO configuration comprises prioritizing a single connectivity CHO configuration in response to the single connectivity CHO configuration having secondary cell group bearers mapped to a respective target master node, and prioritizing a dual connectivity CHO configuration in response to the dual connectivity CHO configuration having the secondary cell group bearers mapped to a respective target secondary node.

In some embodiments, the assistance information indicates to prioritize a dual connectivity CHO configuration with the primary secondary cell of the source secondary node being maintained. In further embodiments, the assistance information comprises a CHO recovery primary secondary cell selection condition, wherein determining the CHO configuration comprises selecting a CHO configuration with a primary secondary cell fulfilling the primary secondary cell selection condition.

In embodiments, determining a CHO configuration comprises selecting a single connectivity CHO configuration in response to none of at least one primary secondary cell fulfilling the primary secondary cell selection condition. In some further embodiments, the user equipment is further caused to, in response to selecting a single connectivity CHO configuration with the second target master node, transmit cell selection information to the second target master node comprising an indication that none of the at least one primary secondary cell associated with the second target master node fulfilling the primary secondary cell selection condition. In some yet further embodiments, the cell selection information further comprises measurements related to the at least one primary secondary cell associated with the second target master node.

In some embodiments, the cell selection information further comprises measurements related to further cells performed at the user equipment. In further embodiments, the assistance information comprises a single-dual connectivity indicator indicating whether a respective CHO configuration is a single or dual connectivity configuration. In embodiments, the assistance information comprises an identifier of a primary secondary cell indicating which primary secondary cell is included in a respective CHO configuration.

According to a second aspect of the subject disclosure, a source master node (source MN) configured to support establishing connection towards a user equipment configured to support operating in dual connectivity with a primary cell of the source master node and with a primary secondary cell of a source secondary node and supporting conditional handover, CHO, is presented. The source MN comprises at least one processor and at least one memory including computer program code causing the source MN, when executed with the at least one processor, to perform the processed described herein. In particular, the source MN is caused to transmit a plurality of CHO configurations to the user equipment including configurations for conditional handover towards at least one target master node and at least one target secondary node and to transmit assistance information for CHO recovery to the user equipment, wherein the assistance information is used by the user equipment for determining a CHO configuration from the plurality of CHO configurations for CHO recovery.

In embodiments, the assistance information comprises a single-dual connectivity prioritization flag for prioritizing single or dual connectivity for CHO recovery. In some embodiments, the single-dual connectivity prioritization flag is determined based on pending traffic volumes on secondary cell group bearers for prioritizing a single connectivity CHO configuration in response to the single connectivity CHO configuration having secondary cell group bearers mapped to a respective target master node, and prioritizing a dual connectivity CHO configuration in response to the dual connectivity CHO configuration having the secondary cell group bearers mapped to a respective target secondary node.

In some embodiments, the assistance information indicates to prioritize a dual connectivity CHO configuration with the primary secondary cell of the source secondary node being maintained. In some embodiments, the assistance information comprises a CHO recovery primary secondary cell selection condition for determining a CHO configuration with a primary secondary cell fulfilling the primary secondary cell selection condition. In further embodiments, the assistance information comprises a single-dual connectivity indicator indicating whether a respective CHO configuration is a single or dual connectivity configuration. In yet further embodiments, the assistance information comprises an identifier of a primary secondary cell indicating which primary secondary cell is included in a respective CHO configuration.

According to a third aspect of the subject disclosure, a network node that supports at least one of central unit control plane functionality or a layer 3 protocol of a radio access network, configured to support connection with a user equipment operating in dual connectivity with a primary cell of the network node and with a primary secondary cell of a source secondary node, and configured for conditional handover, CHO, is presented. The network node comprises at least one processor and at least one memory including computer program code causing the network node, when executed with the at least one processor, to perform the processes described herein. In particular, the network node is caused to generate a Radio Resource Control, RRC, message comprising assistance information for CHO recovery and to transmit the RRC message comprising the assistance information to the user equipment, wherein the assistance information is used by the user equipment for determining a CHO configuration from a plurality of CHO configurations including configurations for conditional handover towards at least one target master node and at least one target secondary node for CHO recovery.

In embodiments, the assistance information comprises a single-dual connectivity prioritization flag for prioritizing single or dual connectivity for CHO recovery. In some embodiments, the the single-dual connectivity prioritization flag is determined based on pending traffic volumes on secondary cell group bearers for prioritizing a single connectivity CHO configuration in response to the single connectivity CHO configuration having secondary cell group bearers mapped to a respective target master node, and prioritizing a dual connectivity CHO configuration in response to the dual connectivity CHO configuration having the secondary cell group bearers mapped to a respective target secondary node.

In some embodiments, the assistance information indicates to prioritize a dual connectivity CHO configuration with the primary secondary cell of the source secondary node being maintained. In some embodiments. the assistance information comprises a CHO recovery primary secondary cell selection condition for determining a CHO configuration with a primary secondary cell fulfilling the primary secondary cell selection condition. In further embodiments, the assistance information comprises a single-dual connectivity indicator indicating whether a respective CHO configuration is a single or dual connectivity configuration. In yet further embodiments, the assistance information comprises an identifier of a primary secondary cell indicating which primary secondary cell is included in a respective CHO configuration.

According to a fourth aspect of the subject disclosure, a method of conditional handover, CHO, recovery, performed by a user equipment configured to operate in dual connectivity within at least one radio access network, RAN, is presented. The method comprises establishing a connection towards a primary cell of a source master node, establishing a connection towards a primary secondary cell of a source secondary node, receiving a plurality of CHO configurations from the source master node including configurations for conditional handover towards at least one target master node and at least one target secondary node, and receiving assistance information for CHO recovery from the source master node. The method further comprises, in response to the user equipment experiencing radio link failure on the primary cell of the source master node or handover failure towards a primary cell of a first target master node, determining a primary cell of a second target master node and an associated CHO configuration from the plurality of CHO configurations based on the assistance information for CHO recovery, and performing CHO recovery towards the primary cell of the second target master node based on the determined associated CHO configuration.

In embodiments, the method further comprises, in response to the determined CHO configuration being a dual connectivity CHO configuration with a primary secondary cell of a target secondary node being different to a primary secondary cell of the source secondary node, perform CHO recovery towards the primary secondary cell of the target secondary node.

In some embodiments, the assistance information comprises a single-dual connectivity prioritization flag for prioritizing single or dual connectivity for CHO recovery. In further embodiments, the assistance information comprises information on pending traffic volumes on secondary cell group bearers, wherein determining the CHO configuration comprises prioritizing a single connectivity CHO configuration in response to the single connectivity CHO configuration having secondary cell group bearers mapped to a respective target master node, and prioritizing a dual connectivity CHO configuration in response to the dual connectivity CHO configuration having the secondary cell group bearers mapped to a respective target secondary node.

In some embodiments, the assistance information indicates to prioritize a dual connectivity CHO configuration with the primary secondary cell of the source secondary node being maintained. In further embodiments, the assistance information comprises a CHO recovery primary secondary cell selection condition, wherein determining the CHO configuration comprises selecting a CHO configuration with a primary secondary cell fulfilling the primary secondary cell selection condition.

In embodiments, determining a CHO configuration comprises selecting a single connectivity CHO configuration in response to none of at least one primary secondary cell fulfilling the primary secondary cell selection condition. In some further embodiments, the user equipment is further caused to, in response to selecting a single connectivity CHO configuration with the second target master node, transmit cell selection information to the second target master node comprising an indication that none of the at least one primary secondary cell associated with the second target master node fulfilling the primary secondary cell selection condition. In some yet further embodiments, the cell selection information further comprises measurements related to the at least one primary secondary cell associated with the second target master node.

In some embodiments, the cell selection information further comprises measurements related to further cells performed at the user equipment. In further embodiments, the assistance information comprises a single-dual connectivity indicator indicating whether a respective CHO configuration is a single or dual connectivity configuration. In embodiments, the assistance information comprises an identifier of a primary secondary cell indicating which primary secondary cell is included in a respective CHO configuration.

According to a fifth aspect of the subject disclosure, a method of conditional handover, CHO, recovery performed by a source master node connected with a user equipment operating in dual connectivity with a primary cell of the source master node and with a primary secondary cell of a source secondary node, is presented the method comprises transmitting a plurality of CHO configurations to the user equipment including configurations for conditional handover towards at least one target master node and at least one target secondary node and transmitting assistance information for CHO recovery to the user equipment, wherein the assistance information is used by the user equipment for determining a CHO configuration from the plurality of CHO configurations for CHO recovery.

In embodiments, the assistance information comprises a single-dual connectivity prioritization flag for prioritizing single or dual connectivity for CHO recovery. In some embodiments, the single-dual connectivity prioritization flag is determined based on pending traffic volumes on secondary cell group bearers for prioritizing a single connectivity CHO configuration in response to the single connectivity CHO configuration having secondary cell group bearers mapped to a respective target master node, and prioritizing a dual connectivity CHO configuration in response to the dual connectivity CHO configuration having the secondary cell group bearers mapped to a respective target secondary node.

In some embodiments, the assistance information indicates to prioritize a dual connectivity CHO configuration with the primary secondary cell of the source secondary node being maintained. In some embodiments, the assistance information comprises a CHO recovery primary secondary cell selection condition for determining a CHO configuration with a primary secondary cell fulfilling the primary secondary cell selection condition. In further embodiments, the assistance information comprises a single-dual connectivity indicator indicating whether a respective CHO configuration is a single or dual connectivity configuration. In yet further embodiments, the assistance information comprises an identifier of a primary secondary cell indicating which primary secondary cell is included in a respective CHO configuration.

The above-noted aspects and features may be implemented in systems, apparatuses, methods, articles and non-transitory computer-readable media depending on the desired configuration. The subject disclosure may be implemented in and used with a number of different types of devices, including but not limited to cellular phones, tablet computers, wearable computing devices, portable media players, and any of various other computing devices.

This summary is intended to provide a brief overview of some of the aspects and features according to the subject disclosure. Accordingly, it will be appreciated that the above-described features are merely examples and should not be construed to narrow the scope of the subject disclosure in any way. Other features, aspects, and advantages of the subject disclosure will become apparent from the following detailed description, drawings and claims.

### List of Abbreviations

In the subject disclosure, the following abbreviations are used and should be understood in accordance with the given definitions:
3GPP 3^{rd} Generation Partnership Project
5G 5^{th} Generation (Mobile Communication Network)
5GC 5G Core Network
NG-RAN Next-Generation Radio Access Network
NR New Radio, 5G
LTE Long-Term Evolution, 4G
BS Base Station
UE User Equipment
HO Handover
CHO Conditional Handover
DC Dual Connectitivy
gNB gNodeB (NR)
eNB eNodeB (LTE)
SCG Secondary Cell Group
MCG Master Cell Group
PCell Primary Cell
PSCell Primary Secondary Cell
MN Master/Main Node
SN Secondary Node
RRC Radio Resource Control Reconfiguration
SRB Signaling Radio Bearer
gNB-CU-CP gNodeB Central Unit Control Plane
gNB-CU-UP gNodeB Central Unit User Plane
gNB-DU gNodeB Distributed Unit
CPC Conditional PSCell Change

### BRIEF DESCRIPTION OF THE DRAWINGS

A better understanding of the subject disclosure can be obtained when the following detailed description of various embodiments is considered in conjunction with the following drawings, in which:

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIGS. 4A and 4B depict an NG-RAN architecture;

FIG. 5 presents a flow chart for dual connectivity conditional handover recovery executed by a user equipment;

FIG. 6 presents a flow chart for dual connectivity conditional handover recovery executed by a source master node;

FIG. 7 presents a flow chart for dual connectivity conditional handover recovery executed by a network node supporting layer 3 functionality;

FIG. 8 shows a message flow diagram of an exemplary overall dual connectivity conditional handover recovery;

FIG. 9 shows another message flow diagram of an exemplary overall dual connectivity conditional handover recovery; and

FIG. 10 presents a flow chart of an embodiment for overall dual connectivity conditional handover recovery.

### DETAILED DESCRIPTION

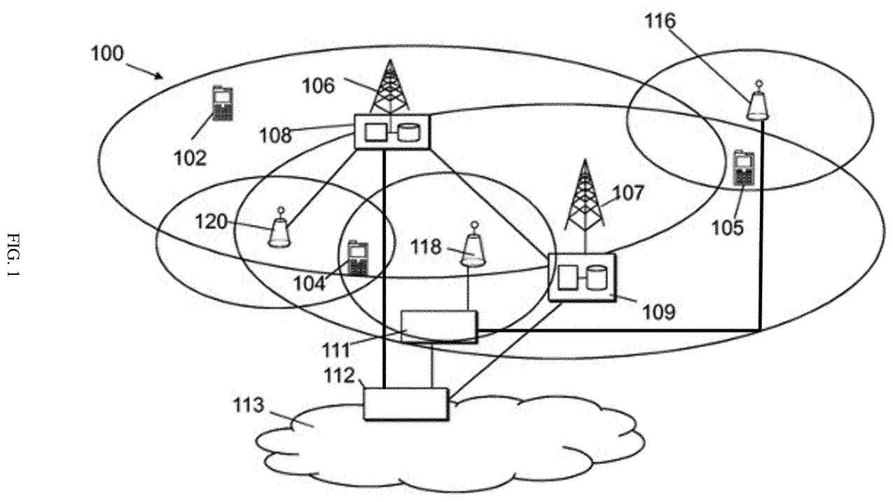

Before explaining the examples in detail, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices, user devices, User Equipment (UE) 102, 104, 105 are provided wireless access via at least one base station (e.g., next generation NB, gNB), similar wireless transmitting and/or receiving node or network node. Base stations may be controlled or assisted by at least one appropriate controller apparatus, so as to enable operation thereof and management of mobile communication devices in communication with the base stations. The controller apparatus may be located in a Radio Access Network (RAN) (e.g., wireless communication system 100) or in a Core Network (CN) (not shown) and may be implemented as one central apparatus or its functionality may be distributed over several apparatuses. The controller apparatus may be part of the base station and/or provided by a separate entity such as a Radio Network Controller (RNC). In FIG. 1, control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in the RNC.

In FIG. 1, base stations 106 and 107 are shown as connected to a wider communications network 113 via gateway 112. A further gateway function may be provided to connect to another network.

As used herein, the term “base station” has the full breadth of its ordinary meaning, and at least includes a wireless communication station installed at a fixed location and used to communicate as part of a wireless telephone system or radio system. The communication area (or coverage area) of the base stations may be referred to as a “cell.” The base stations and the UEs may be configured to communicate over the transmission medium using any of various Radio Access Technologies (RATs), also referred to as wireless communication technologies, or telecommunication standards described hereinbelow. As illustrated in FIG. 1, while one of the base stations may act as a “serving cell” for UEs, an UE may also be capable of receiving signals from (and possibly within communication range of) one or more other cells (which might be provided by the base stations and/or any other base stations), which may be referred to as “neighboring cells”.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example, Wireless Local Area Network (WLAN) and may be WLAN Access Points (APs). The communication devices 102, 104, 105 may access the communication system based on various access techniques, such as Code Division Multiple Access (CDMA), or Wideband CDMA (WCDMA). Other non-limiting examples comprise Time Division Multiple Access (TDMA), Frequency Division Multiple Access (FDMA) and various schemes thereof such as the Interleaved Frequency Division Multiple Access (IFDMA), Single Carrier Frequency Division Multiple Access (SC-FDMA) and Orthogonal Frequency Division Multiple Access (OFDMA), Space Division Multiple Access (SDMA) and so on.

An example of wireless communication systems are architectures standardized by the 3rd Generation Partnership Project (3GPP). A latest 3GPP based development is often referred to as the Long-Term Evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (or LTE-A) employs a radio mobile architecture known as the Evolved Universal Terrestrial Radio Access Network (E-UTRAN) and a Core Network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as WLAN and/or Worldwide interoperability for Microwave access (WiMax). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-A. Base stations of NR systems may be known as next generation Node Bs (gNBs). Changes to the network architecture may depend on the need to support various radio technologies and finer Quality of Service (QoS) support, and some on-demand requirements for QoS levels to support Quality of Experience (QoE) of user point of view. Also network aware services and applications, and service and application aware networks may bring changes to the architecture. Those are related to Information Centric Network (ICN) and User-Centric Content Delivery Network (UC-CDN) approaches. NR may use Multiple Input-Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilize Network Functions Virtualization (NFV) which is a network architecture concept that proposes virtualizing network node functions into “building blocks” or entities that may be operationally connected or linked together to provide services. A Virtualized Network Function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

An example 5G Core Network (CN) comprises functional entities. The CN is connected to a UE via the Radio Access Network (RAN). A User Plane Function (UPF) whose role is called PDU Session Anchor (PSA) may be responsible for forwarding frames back and forth between the Data Network (DN) and the tunnels established over the 5G towards the UEs exchanging traffic with the DN.

The UPF is controlled by a Session Management Function (SMF) that receives policies from a Policy Control Function (PCF). The CN may also include an Access and Mobility Function (AMF).

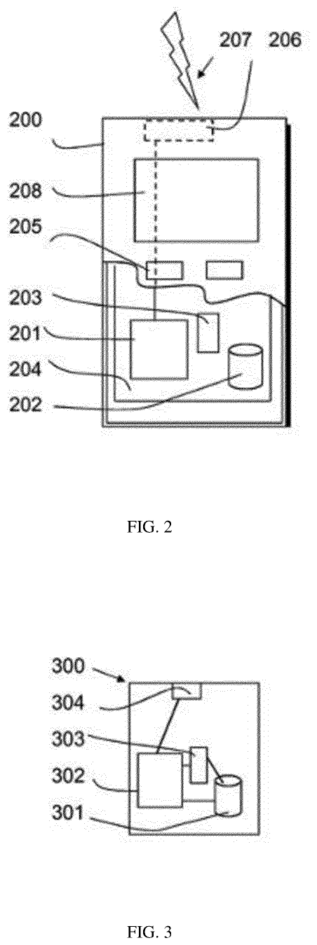

A possible (mobile) communication device 200 will now be described in more detail with reference to FIG. 2 showing a schematic, partially sectioned view. Such a mobile communication device 200 is often referred to as User Equipment (UE), user device or terminal device. An appropriate mobile communication device 200 may be provided by any device capable of sending and receiving radio signals. Non-limiting examples comprise a Mobile Station (MS) or mobile device such as a mobile phone or what is known as a smart phone, a computer provided with a wireless interface card or other wireless interface facility (e.g., USB dongle), Personal Data Assistant (PDA) or a tablet provided with wireless communication capabilities, or any combinations of these or the like. The communication device 200 may provide, for example, communication of data for carrying communications such as voice, electronic mail (e-mail), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

In an industrial application a communication device may be a modem integrated into an industrial actuator (e.g., a robot arm) and/or a modem acting as an Ethernet-hub that will act as a connection point for one or several connected Ethernet devices (which connection may be wired or unwired).

The communication device 200 is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets 204. The user may control the operation of the communication device 200 by means of a suitable user interface such as keypad 205, voice commands, touch sensitive screen or pad, combinations thereof or the like. A display 208, a speaker and a microphone can be also provided. Furthermore, the communication device 200 may comprise appropriate connectors (either wired or wireless) to other devices and/or for connecting external accessories, for example hands-free equipment, thereto.

The communication device 200 may receive signals over an air or radio interface 207 via appropriate apparatus for receiving and may transmit signals via appropriate apparatus for transmitting radio signals. In FIG. 2, transceiver apparatus is designated schematically by block 206. The transceiver apparatus 206 may be provided for example by means of a radio part and associated antenna arrangement. The antenna arrangement may be arranged internally or externally to the communication device 200.

The communication device 200 may also or alternatively be configured to communicate using one or more Global Navigational Satellite Systems (GNSS such as GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Generally, the communication device 200 illustrated in FIG. 2 includes a set of components configured to perform core functions. For example, this set of components may be implemented as a system on chip (SoC), which may include portions for various purposes. Alternatively, this set of components may be implemented as separate components or groups of components for the various purposes. The set of components may be (communicatively) coupled (e.g., directly or indirectly) to various other circuits of the communication device 200.

The communication device 200 may include at least one antenna in communication with a transmitter and a receiver (e.g., the transceiver apparatus 206). Alternatively, transmit and receive antennas may be separate. The communication device 200 may also include a processor (e.g., the at least one data processing entity 201) configured to provide signals to and receive signals from the transmitter and receiver, respectively, and to control the functioning of the communication device 200. The processor may be configured to control the functioning of the transmitter and receiver by effecting control signaling via electrical leads to the transmitter and receiver. Likewise, the processor may be configured to control other elements of the communication device 200 by effecting control signaling via electrical leads connecting processor to the other elements, such as a display (e.g., display 208) or a memory (e.g., the at least one memory 202). The processor may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an Application Specific Integrated Circuit (ASIC), a Field Programmable Gate Array (FPGA), and/or the like, or some combination thereof. Accordingly, in some examples, the processor may comprise a plurality of processors or processing cores.

The communication device 200 may be capable of operating with one or more air interface standards, communication protocols, modulation types, access types, and/or the like. Signals sent and received by the processor may include signaling information in accordance with an air interface standard of an applicable cellular system, and/or any number of different wireline or wireless networking techniques, comprising but not limited to Wi-Fi, WLAN techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the communication device 200 and/or a cellular modem therein may be capable of operating in accordance with various 3rd Generation (3G) communication protocols, 4th generation (4G) communication protocols, 5^{th} Generation (5G) communication protocols, Internet Protocol Multimedia Subsystem (IMS) communication protocols such as, for example, Session Initiation Protocol (SIP) and/or the like, or 5G beyond. For example, the communication device 200 may be capable of operating in accordance with 4G wireless communication protocols, such as LTE-A, 5G, and/or the like as well as similar wireless communication protocols that may be subsequently developed.

It is understood that the processor may include circuitry for implementing audio/video and logic functions of the communication device 200. For example, the processor may comprise a digital signal processor device, a microprocessor device, an analog-to-digital converter, a digital-to-analog converter, and/or the like. Control and signal processing functions of the communication device 200 may be allocated between these devices according to their respective capabilities. The processor may additionally comprise an internal voice coder, an internal data modem, and/or the like. Further, the processor may include functionality to operate one or more software programs, which may be stored in memory. In general, the processor and stored software instructions may be configured to cause the communication device 200 to perform actions. For example, the processor may be capable of operating a connectivity program, such as a web browser. The connectivity program may allow the communication device 200 to transmit and receive web content, such as location-based content, according to a protocol, such as Wireless Application Protocol (WAP), HyperText Transfer Protocol (HTTP), and/or the like.

The communication device 200 may also comprise a user interface including, for example, an earphone or speaker, a ringer, a microphone, a display, a user input interface, and/or the like, which may be operationally coupled to the processor. The display may, as noted above, include a touch sensitive display, where a user may touch and/or gesture to make selections, enter values, and/or the like. The processor may also include user interface circuitry configured to control at least some functions of one or more elements of the user interface, such as the speaker, the ringer, the microphone, the display, and/or the like. The processor and/or user interface circuitry comprising the processor may be configured to control one or more functions of one or more elements of the user interface through computer program instructions, for example, software and/or firmware, stored on a memory accessible to the processor, for example, volatile memory, non-volatile memory, and/or the like. The communication device 200 may include a battery for powering various circuits related to the mobile terminal, for example, a circuit to provide mechanical vibration as a detectable output. The user input interface may comprise devices allowing the communication device 200 to receive data, such as a keypad (e.g., keypad 206) and/or other input devices. The keypad can also be a virtual keyboard presented on display or an externally coupled keyboard.

The communication device 200 may also include one or more mechanisms for sharing and/or obtaining data. For example, the communication device 200 may include a short-range radio frequency (RF) transceiver and/or interrogator, so data may be shared with and/or obtained from electronic devices in accordance with RF techniques. The communication device 200 may include other short-range transceivers, such as an infrared (IR) transceiver, a Bluetooth™ (BT) transceiver operating using Bluetooth™ wireless technology, a wireless Universal Serial Bus (USB) transceiver, a Bluetooth™ Low Energy transceiver, a ZigBee transceiver, an ANT transceiver, a cellular device-to-device transceiver, a wireless local area link transceiver, and/or any other short-range radio technology. The communication device 200 and more specifically, the short-range transceiver may be capable of transmitting data to and/or receiving data from electronic devices within the proximity of the apparatus, such as within 10 meters, for example. The communication device 200 including the Wi-Fi or WLAN modem may also be capable of transmitting and/or receiving data from electronic devices according to various wireless networking techniques, including 6LoWPAN, Wi-Fi, Wi-Fi low power, WLAN techniques such as IEEE 802.11 techniques, IEEE 802.15 techniques, IEEE 802.16 techniques, and/or the like.

The communication device 200 may comprise memory, such as one or more Subscriber Identity Modules (SIM), one or more Universal Subscriber Identity Modules (USIM), one or more removable User Identity Modules (R-UIM), one or more Embedded Universal Integrated Circuit Cards (eUICCs), one or more Universal Integrated Circuit Cards (UICC), and/or the like, which may store information elements related to a mobile subscriber. In addition, the communication device 200 may include other removable and/or fixed memory. The communication device 200 may include volatile memory and/or non-volatile memory. For example, the volatile memory may include Random Access Memory (RAM) including dynamic and/or static RAM, on-chip or off-chip cache memory, and/or the like. The non-volatile memory, which may be embedded and/or removable, may include, for example, read-only memory, flash memory, magnetic storage devices, for example, hard disks, floppy disk drives, magnetic tape, optical disc drives and/or media, non-volatile random-access memory (NVRAM), and/or the like. Like volatile memory, the non-volatile memory may include a cache area for temporary storage of data. At least part of the volatile and/or non-volatile memory may be embedded in the processor. The memories may store one or more software programs, instructions, pieces of information, data, and/or the like which may be used by the apparatus for performing operations disclosed herein.

The memories may comprise an identifier, such as an International Mobile Equipment Identification (IMEI) code, capable of uniquely identifying the communication device 200. In the example embodiment, the processor may be configured using computer code stored at memory to cause the processor to perform operations disclosed herein.

Some of the embodiments disclosed herein may be implemented in software, hardware, application logic, or a combination of software, hardware, and application logic. The software, application logic, and/or hardware may reside on the memory, the processor, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 2, computer-readable medium may comprise a non-transitory computer-readable storage medium that may be any media that can contain or store the instructions for use by or in connection with an instruction execution system, apparatus, or device, such as a computer.

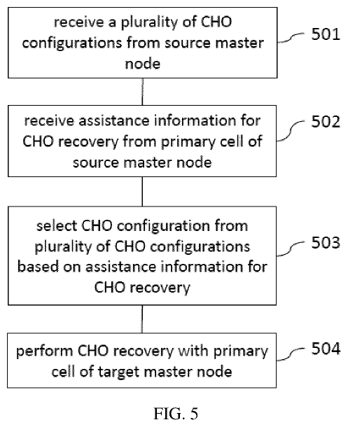

In some embodiments, the communication device 200 (i.e., UE or a user device in a network) comprises the processor (e.g., the at least one data processing entity 201) and the memory (e.g., the at least one memory 202). The memory includes computer program code causing the communication device 200 to perform processing according to the methods described below with reference to FIG. 5.

FIG. 3 shows an example embodiment of a control apparatus for a communication system, for example to be coupled to and/or for controlling a station of an access system, such as a RAN node, e.g., a base station, eNB or gNB, a relay node or a core network node such as an MME or S-GW or P-GW, or a core network function such as AMF/SMF, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as an RNC or a spectrum controller. In some embodiments, an base station may have such a control apparatus as well as a control apparatus being provided in an RNC. The control apparatus 300 can be arranged to provide control on communications in the service area of the system. The control apparatus 300 comprises at least one memory 301, at least one data processing unit 302, 303 and an input/output interface 304. Via the interface the control apparatus 300 can be coupled to a receiver and a transmitter of the base station. The receiver and/or the transmitter may be implemented as a radio front end or a remote radio head.

Generally, the control apparatus 300 has an antenna, which transmits and receives radio signals. A radio frequency (RF) transceiver module, coupled with the antenna, receives RF signals from antenna, converts them to baseband signals and sends them to processor (e.g., the at least one data processing unit 302, 303). RF transceiver also converts received baseband signals from processor, converts them to RF signals, and sends out to antenna. A processor processes the received baseband signals and invokes different functional modules to perform features in control apparatus 300. Memory (e.g., the at least one memory 301) stores program instructions and data to control the operations of the control apparatus 300. In the example of FIG. 3, the control apparatus 300 also includes protocol stack and a set of control functional modules and circuit. PDU session handling circuit handles PDU session establishment and modification procedures. Policy control module that configures policy rules for UEs. Configuration and control circuit provides different parameters to configure and control UEs of related functionalities including mobility management and session management. Suitable processors include, by way of example, a special purpose processor, a digital signal processor (DSP), a plurality of micro-processors, one or more micro-processor associated with a DSP core, a controller, a microcontroller, ASICs, FPGA circuits, and other type of integrated circuits (ICs), and/or state machines.

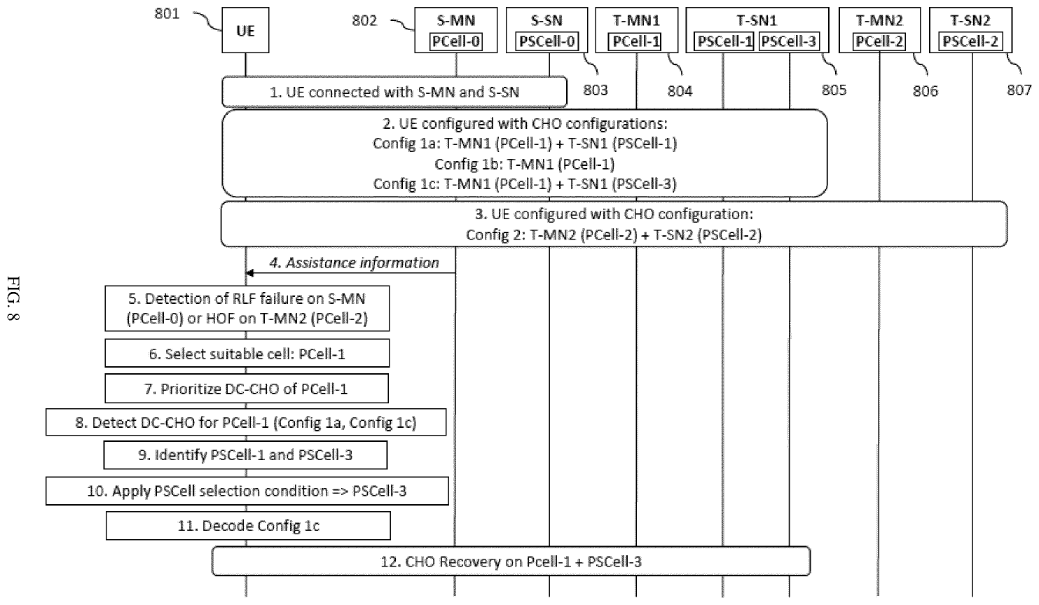

In some embodiments, the control apparatus 300 (i.e., a base station, a wireless transmitting and/or receiving point equipment, or a network node in a network) comprises the processor (e.g., the at least one data processing unit 302, 303) and the memory (e.g., the at least one memory 301). The memory includes computer program code causing the control apparatus 300 to perform processing according to the method described below with reference to FIG. 6.

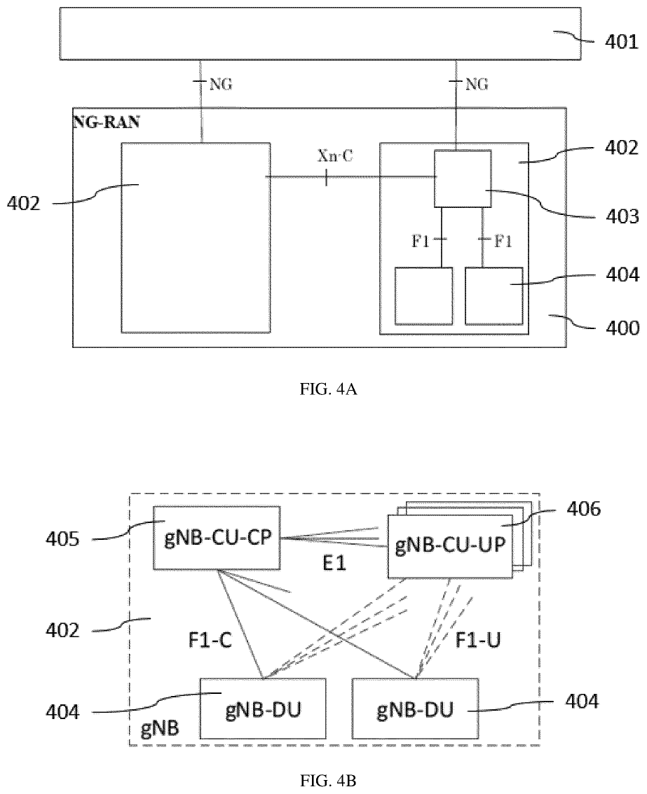

FIGS. 4A and 4B depict a next-generation radio access network (NG-RAN) architecture 400 with gNBs 402 according to 3GPP TS38.401 V17.0.0. A gNB 402 employs NR user/control plane protocols to serve UEs and is connected to the 5GC 401 via the NG interface and to other gNBs 402 through Xn interface. The gNB 402 of FIG. 4A comprises a central unit (i.e., gNB-CU) 403 and one or more distributed units (i.e., gNB-DU) 404. The gNB-CU is a logical node hosting RRC, SDAP and PDCP protocols of the gNB or RRC and PDCP protocols of the en-gNB that controls the operation of one or more gNB-DUs 404. The gNB-CU 403 terminates the F1 interface connected with the gNB-DU 404. The dNB-DU 404 is a logical node hosting RLC, MAC and PHY layers of the gNB 402 or en-gNB, and its operation is partly controlled by gNB-CU 403. One gNB-DU 404 supports one or multiple cells. One cell is supported by one gNB-DU 404. The gNB-DU 404 terminates the F1 interface connected with the gNB-CU 403.

One gNB-DU 404 is connected to one gNB-CU 403 via F1 interface. NG, Xn, and F1 are logical interfaces. The Xn-C interface interconnects gNB-CUs 403 of different gNBs 402. The gNB 402 can also comprise a gNB-CU control-plane (gNB-CU-CP), multiple gNB-CU user-plane (gNB-CU-UPs), and multiple gNB-DUs, which are depicted in more detail in FIG. 4B.

It should be noted that NG-RAN could also comprise a set of ng-eNBs, an ng-eNB may comprise an ng-eNB-CU and one or more ng-eNB-DU(s). An ng-eNB-CU and an ng-eNB-DU is connected via W1 interface.

FIG. 4B illustrates the architecture with separation of the control plane and the user plane for the gNB-CU (i.e., gNB-CU-CP and gNB-CU-UP) 403. The gNB-CU-CP 405 is a logical node hosting the RRC and the control plane part of the PDCP protocol of the gNB-CU 403 for an en-gNB or a gNB 402. The gNB-CU-CP 405 terminates the E1 interface connected with the gNB-CU-UP 406 and the F1-C interface connected with the gNB-DU 404. The gNB-CU-UP 406 is a logical node hosting the user plane part of the PDCP protocol of the gNB-CU 403 for an en-gNB, and the user plane part of the PDCP protocol and the SDAP protocol of the gNB-CU 403 for a gNB 402. The gNB-CU-UP 406 terminates the E1 interface connected with the gNB-CU-CP 405 and the F1-U interface connected with the gNB-DU 404. The gNB-CU-UP 406 is connected to one gNB-CU-CP 405, to multiple gNB-CU-UPs 406 and multiple gNB-DUs 404 under the control of the same gNB-CU-CP 405.

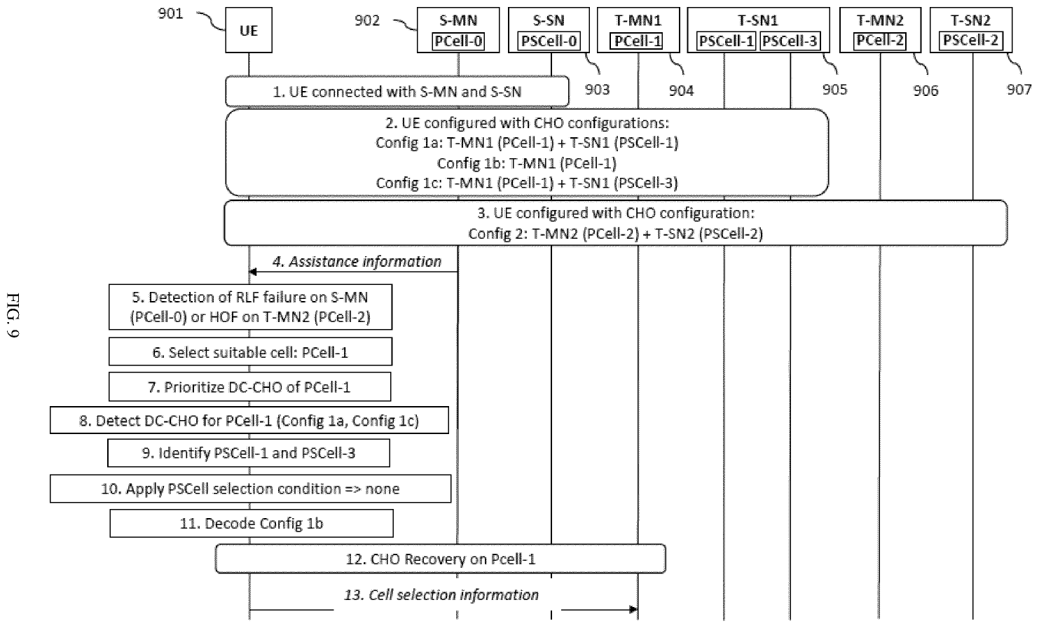

In some embodiments, the gNB-CU-CP 405 is associated to a processor and a memory. The memory includes computer program code causing the gNB supporting the functionality of gNB-CU-CP 405 to perform processing according to the method described below with reference to FIG. 7.

The following description may provide further details of alternatives, modifications and variances: a gNB may comprise, e.g., a node providing NR user plane and control plane protocol terminations towards the UE, and connected via the NG interface to the 5GC, e.g., according to 3GPP TS 38.300 V17.0.0 incorporated herein by reference.

A gNB Central Unit (gNB-CU) comprises e.g. a logical node hosting e.g. RRC, SDAP and PDCP protocols of the gNB or RRC and PDCP protocols of the en-gNB that controls the operation of one or more gNB-DUs. The gNB-CU terminates the F1 interface connected with the gNB-DU. A gNB Distributed Unit (gNB-DU) comprises e.g. a logical node hosting e.g. RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g. a logical node hosting e.g. the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU. A gNB-CU-User Plane (gNB-CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V17.0.0, section 3.1 incorporated herein by reference.

Different functional splits between the central and distributed unit are possible, e.g. called options: Option 1 (1A-like split), in which the function split is similar to the 1A architecture in DC. RRC is in the central unit. PDCP, RLC, MAC, physical layer and RF are in the distributed unit. Option 2 (3C-like split), in which the function split is similar to the 3C architecture in DC. RRC and PDCP are in the central unit. RLC, MAC, physical layer and RF are in the distributed unit. Option 3 (intra RLC split), in which low RLC (partial function of RLC), MAC, physical layer, and RF are in the distributed unit. PDCP and high RLC (the other partial function of RLC) are in the central unit. Option 4 (RLC-MAC split), in which MAC, physical layer, and RF are in the distributed unit. PDCP and RLC are in the central unit. Or else, e.g., according to 3GPP TR 38.801 V14.0.0, section 11 incorporated by reference.

A gNB supports different protocol layers, e.g., Layer 1 (L1)-physical layer.The layer 2 (L2) of NR is split into the following sublayers: Medium Access Control (MAC), Radio Link Control (RLC), Packet Data Convergence Protocol (PDCP), and Service Data Adaptation Protocol (SDAP), The physical layer may offer to the MAC sublayer transport channels; the MAC sublayer may offer to the RLC sublayer logical channels, the RLC sublayer may offer to the PDCP sublayer RLC channels, the PDCP sublayer may offer to the SDAP sublayer radio bearers, and the SDAP sublayer may offer to 5GC QoS flows. Control channels include, e.g., BCCH, PCCH. Layer 3 (L3) includes, e.g., Radio Resource Control (RRC), e.g. according to 3GPP TS 38.300 V17.0.0, section 6 incorporated herein by reference.

A RAN (Radio Access Network) node or network node like a gNB, base station, gNB-CU, or gNB-DU. or parts thereof may be implemented using, e.g., an apparatus with at least one processor and/or at least one memory (with computer-readable instructions (computer program)) configured to support and/or provision and/or process CU and/or DU related functionality and/or features, and/or at least one protocol (sub-) layer of a RAN (Radio Access Network), e.g. layer 2 and/or layer 3.

The gNB-CU and gNB-DU parts may, e.g., be co-located or physically separated. The gNB-DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. A gNB-DU supports one or multiple cells, and could thus serve as e.g. a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g., according to 3GPP TS 38.331 V17.0.0, sections 4.2.1 and 4.4, incorporated herein by reference). A UE is, e.g., either in RRC CONNECTED state or in RRC_INACTIVE state when an RRC connection has been established. In RRC_CONNECTED state a UE may store the AS context, transfer unicast data to/from the UE, monitor control channels associated with the shared data channel to determine if data is scheduled for the data channel, provide channel quality and feedback information, and/or perform neighboring cell measurements and measurement reporting. The RRC protocol includes, e.g., the following main functions: RRC connection control, measurement configuration and reporting, establishment/modification/release of measurement configuration (e.g. intra-frequency, inter-frequency and inter-RAT measurements), setup and release of measurement gaps, and/or measurement reporting.

Before referring to FIGS. 5 to 8 and describing the of dual connectivity conditional handover recovery according to some embodiments of the subject disclosure, some background information and aspects related to the subject disclosure will be provided.

For example, the subject disclosure may be incorporated in a network that supports dual connectivity (DC) and conditional handover (CHO). CHO procedure has been introduced in 3GPP Rel. 16 to improve the mobility robustness. In case of CHO, the network may prepare multiple target cells where conditional handover reconfiguration is associated with a CHO execution condition that is evaluated by the UE. The CHO execution condition refers to a measurement ID (associating a measurement object with a reporting configuration) that is configured by source gNB. The reporting configuration defines the measurement event (e.g., measurement events A3 or A5 as defined in the 3GPP standards) which triggers the CHO execution. Whenever CHO execution condition is met, the corresponding target CHO configuration is selected and handover is executed towards the selected target cell.

In CHO, UE is served by a Primary Cell (PCell) in a source master node (MN) and a Primary Secondary Cell (PSCell) in a source secondary node (SN). UE sends the measurement report to its serving PCell to initiate the CHO preparation of a PCell in a target MN. Source PCell prepares the target PCell and sends UE the CHO preparation, i.e., CHO configuration of a target PCell and/or target PSCell, along with the CHO execution condition in an RRC Reconfiguration message. Once the CHO execution condition against one of the target PCells is met, UE detaches from source PCell, i.e., stops TX/RX to/from source PCell. The UE initiates the random access procedure towards the target PCell. Once the random access procedure is completed successfully, the target PCell of the target MN notifies the source PCell of the source MN about successful completion of the handover procedure. Upon receiving a handover success indication from the target MN, the source PCell in the source MN initiates the data forwarding to the target PCell of the target MN. Once the data forwarding procedure is completed, UE will continue its data transmission/reception with the network.

However, it may happen that the UE experiences bad radio link quality for a given period of time, even with CHO. Currently, the UE declares failure and initiates re-establishment procedure to reconnect to the network which cost additional signaling overhead and delay during re-establishment procedure.

To overcome this issue, CHO recovery has been introduced by 3GPP in release 16 of NR standards. CHO recovery (e.g., as described in 3GPP TS 38.311 V17.0.0, section 5.3.7.3) reduces the interruption time caused by failures for UEs that are configured with conditional reconfigurations for multiple target cells. Despite CHO minimizing the probability of mobility failures, it is still possible that UE detects a failure due to misconfiguration of the mobility parameters or handover execution to wrong cell. Instead of performing re-establishment, a UE supporting CHO recovery feature can make use of the stored conditional reconfiguration for prepared target cells to recover from the failure.

After the failure is detected, the UE initiates the cell reselection procedure and, if the selected cell is one of the prepared target cells in CHO, UE executes the handover towards that cell using the CHO configuration that was provided previously by the network. Otherwise, the UE initiates the re-establishment procedure to the selected cell if it does not have a corresponding CHO configuration. Hence, using CHO recovery, the UE can leverage the stored CHO configurations for target cells to initiate a CHO execution instead of costly re-establishment procedure, reducing thereby the interruption time after the failure.

CHO recovery mechanism allows the UE to recover on a cell with stored CHO configuration. In case of CHO with DC, i.e., CHO with multiple candidate secondary cell groups (SCGs) and/or multiple CHO configurations of target PCells and target PSCells, where the UE may apply a dual connectivity CHO (CHO-DC) configuration when the CHO condition is met, CHO recovery does not consider which or whether SCG shall be considered during CHO execution. This may lead to SCG failure and interruption time on MN/SN terminated SCG bearers if the CHO preparation with proper SCG configuration is not selected.

Currently, the target CHO configuration is selected based only on the radio signal measurements of a target PCell meeting certain cell selection criteria without considering the signal strength/quality of the target PSCells. If more than one CHO configuration is available for the same PCell, UE does not distinguish further between the different dual connectivity CHO (CHO-DC) and single connectivity CHO (CHO-SC) configurations during the CHO recovery procedure. Selection of suitable configuration having same PCell is essential to minimise the performance impact and interruption to current bearers.

Moreover, in case one of the CHO-DC configurations have both suitable PCell and PSCell, UE does not know which CHO configuration is DC or SC since the configuration details are not transparent to the UE unless the UE decodes the configuration. Besides, the UE does not know in which CHO-DC configuration the suitable PSCell is configured until the configuration is decoded.

The solution to these issues according to this disclosure is summarized as follows. The network provides the UE with assistance information to improve the recovery procedure in CHO-DC scenario.

In embodiments, the network may provide an SC/DC prioritization flag to prioritize the CHO configurations of the same PCell during recovery procedure. In additional or alternative embodiment, criteria to prioritize SC or DC configuration can also be based on pending traffic volume for specific SCG bearers instead of direct indication of DC/SC configuration. Therefore, the network may indicate pending traffic volume to UE. Alternatively, the network may configure the SC/DC prioritization flag and choose SC over DC, if the SC configuration have the current SCG bearers mapped to the target SC configuration. If the current SCG bearers are only mapped to target SCG, network may choose DC over SC as there is no benefit for switching to SC.

In further embodiments, network may also or alternatively indicate preference to choose the target DC configuration having same PSCell (SCG-maintained DC handover) that will minimize the interruption for current traffic. In further embodiments, the network may also or alternatively provide a PSCell selection criteria to the UE that is to be met at the time of cell-selection for recovery. This enables the UE to choose the target DC configuration that has a better secondary cell group radio condition. In further embodiments, the network may also or alternatively provide an SC/DC indication outside the CHO configuration so that the UE can identify which CHO configurations are SC or DC. In further embodiments, the network may also or alternatively provide the ID of PSCell along with or outside the CHO-DC configuration so that the UE can identify in which CHO-DC configuration the PSCell is configured. In addition, a fall back from CHO-DC to CHO-SC may be used that allows UE to survive on a PCell if none of the PSCells are suitable on CHO-DC configurations.

A flow chart for dual connectivity conditional handover recovery performed by a UE is presented in FIG. 5. The user equipment comprises at least one processor and at least one memory including computer program code that causes the UE to execute the processes described herein. In other words, the UE is configured to execute the processes described herein.

The UE is operating in dual connectivity, i.e., it is connected with a source base station as master node, also referred to a source MN, and a secondary base station, also referred to as source SN or SN. The processes described with respect to FIG. 5 are executed during conditional handover, e.g., after the UE has been configured with one or more possible target master nodes (also referred to target MN) and/or target secondary nodes (also referred to target SN) for CHO. For example, the source MN may have determined—e.g., based on measurements performed and reported by the UE in a measurement report—that a conditional handover with one or more target MN is to be expected. Afterwards, the source MN may have sent a CHO request to one or more target MN. The one or more (or at least some of those) target MN may have acknowledged the CHO request. In future communication systems, other steps may also possible to be performed before or after the processes described with respect to FIG. 5 are executed.

Starting at box 501, the UE receives a plurality of CHO configurations from the source master node. A CHO configuration relates to at least a primary cell of a target master node but may also comprise a primary secondary cell of the target master node. The CHO configurations may be transmitted to the UE in one message, such as an RRC Reconfiguration message. Alternatively, the CHO configurations may be transmitted in at least two separate messages, one message per CHO configuration or one message per target master node comprising one or more CHO configurations of this target master node. Instead of using an RRC Reconfiguration message of layer 3, other messages of layer 2 or 1, such as MAC signaling or signaling the CHO execution condition via PDCCH, may be used.

In box 502, the UE receives assistance information for CHO recovery from a primary cell of the source master node. The assistance information may be any information according to which the UE may select a CHO configuration from the plurality of CHO configurations.

The assistance information may comprise a single-dual connectivity prioritization flag. Such flag can be used to configure the UE to prioritize a single connectivity CHO configuration over a dual connectivity CHO configuration or vice a versa. For example, if the single-dual connectivity prioritization flag is set to 1, the UE prioritizes dual connectivity (DC) CHO configurations over single connectivity CHO configurations. Otherwise, if the single-dual connectivity prioritization flag is set to 0, the UE prioritizes SC-CHO configurations over DC-CHO configurations.

The assistance information may additionally or alternatively comprise information on pending traffic volumes on secondary cell group bearers. The UE may then be configured to prioritize a single connectivity CHO configuration in response to the single connectivity CHO configuration having the secondary cell group bearers mapped to a respective target master node, and to prioritize a dual connectivity CHO configuration in response to the dual connectivity CHO configuration having the secondary cell group bearers mapped to a respective target secondary node.

The assistance information may additionally or alternatively comprise an indication to prioritize a dual connectivity CHO configuration with the primary secondary cell of the source secondary node being maintained. In such a configuration, the UE will keep its connection to the source SN. The required data forwarding between the nodes is thereby reduced while having a stable connection to the source SN.

The assistance information may additionally or alternatively comprise a primary secondary cell selection condition. The UE may then be configured to select a CHO configuration with a primary secondary cell fulfilling the primary secondary cell selection condition. For example, the primary secondary cell selection condition may comprise a threshold for cell quality and/or any selection conditions based on RSRP, RSRQ or SINR conditions.

The assistance information may additionally or alternatively comprise information about which information is coded in which CHO configuration. For example, the assistance information may comprise a single-dual connectivity indicator indicating which type of CHO configuration is coded in a respective CHO configuration. In another additional or alternative example, the assistance information may comprise an identifier of a primary secondary cell indicating which primary secondary cell is coded in a CHO configuration. In an alternative embodiment, the information about the CHO configurations may also be indicated differently, e.g., by including the information in additional fields accompanying the CHO configurations or by signaling them separately to the assistance information.

The UE then selects a CHO configuration from the plurality of CHO configurations based on the assistance information for CHO recovery as shown in box 503. Such a selection is usually performed in response to the user equipment experiencing radio link failure on the primary cell of the source master node or handover failure on a primary cell of a handover target master node. The selected CHO configuration relates (at least) to a primary cell of a target master node and may also additionally relate to a possible primary secondary cell of a target secondary node to be used for DC in combination with the primary cell.

Finally and as depicted in box 504, the UE performs CHO recovery with the primary cell of the target master node according to the selected CHO configuration. In an embodiment, in which the selected CHO is a dual connectivity CHO configuration with a primary secondary cell of a target secondary node being different to a primary secondary cell of the source secondary node, the UE may also be configured to perform CHO recovery with the primary secondary cell of the target secondary node (in addition to the primary cell of the target master node for enabling DC connection).

Additionally, a fall back may be used that allows UE to survive with single connectivity on a primary cell if none of the primary secondary cells of DC-CHO configurations are suitable. For example, if none of at least one primary secondary cell fulfilling the primary secondary cell selection condition as described above, the UE may be configured to select (or apply) a single connectivity CHO configuration of the target master node. In such an example, the UE may also be configured to transmit cell selection information to the target master node comprising an indication that none of the at least primary secondary cells configured for the target master node fulfilling the primary secondary cell selection condition. This cell selection information may in further embodiments also comprise measurements related to the at least one primary secondary cell configured for the target master node. This information may be used by the network for root-cause analysis. In other additional or alternative embodiments, the cell selection information further comprises measurements related to further cells, e.g., all cells or at least a plurality of cells available for measurements at the user equipment.

The UE may also comprise means for performing the processes described herein. For example, the UE may comprise means for receiving a plurality of CHO configurations from the source master node and means for receiving assistance information for CHO recovery from a primary cell of the source master node. The UE may further comprise means for, in response to the user equipment experiencing radio link failure on the primary cell of the source master node or handover failure on a primary cell of a second target master node, selecting a CHO configuration from the plurality of CHO configurations based on the assistance information for CHO recovery, wherein the selected CHO configuration relates to a primary cell of a target master node. Finally, the UE may comprise means for performing CHO recovery with the primary cell of the target master node. Means for the other herein described processes may be provided as well.

A flow chart for dual connectivity conditional handover recovery performed by a source MN is presented in FIG. 6. The source MN comprises at least one processor and at least one memory including computer program code that causes the source MN to execute the processes described herein. In other words, the source MN is configured to execute the processes described herein. The source MN is connected with a user equipment operating in dual connectivity with a primary cell of the source master node and with a primary secondary cell of a source secondary node and configured for conditional handover, CHO.

To enable the improved CHO recovery mechanism described herein, the source MN transmits a plurality of CHO configurations to the user equipment, e.g., in response to measurements performed and reported by the UE in a measurement report that indicate that a conditional handover with one or more target MN is to be expected. This is shown in box 601 of FIG. 6. A CHO configuration relates to at least a primary cell of a target master node but may also comprise a primary secondary cell of the target master node. The CHO configurations may be transmitted to the UE in one message, such as an RRC Reconfiguration message. Alternatively, the CHO configurations may be transmitted in at least two separate messages, one message per CHO configuration or one message per target master node comprising one or more CHO configurations of this target master node. Instead of using an RRC Reconfiguration message of layer 3, other messages of layer 2 or 1, such as MAC signaling or signaling the CHO execution condition via PDCCH, may be used.

As shown in box 602, the source MN further transmits assistance information for CHO recovery to the user equipment. The assistance information is used by the user equipment for selecting a CHO configuration from the plurality of CHO configurations for CHO recovery as described above with respect to FIG. 5.

The assistance information may comprise a single-dual connectivity prioritization flag. Such flag can be used to configure the UE to prioritize a single connectivity CHO configuration over a dual connectivity CHO configuration or vice a versa. For example, if the single-dual connectivity prioritization flag is set to 1, the UE prioritizes dual connectivity (DC) CHO configurations over single connectivity CHO configurations. Otherwise, if the single-dual connectivity prioritization flag is set to 0, the UE prioritizes SC-CHO configurations over DC-CHO configurations.

The single-dual connectivity prioritization flag may be determined based on pending traffic volumes on secondary cell group bearers. The source MN may then be configured to prioritize a single connectivity CHO configuration in response to the single connectivity CHO configuration having the secondary cell group bearers mapped to a respective target master node, and to prioritize a dual connectivity CHO configuration in response to the dual connectivity CHO configuration having the secondary cell group bearers mapped to a respective target secondary node.

The assistance information may additionally or alternatively comprise an indication to prioritize a dual connectivity CHO configuration with the primary secondary cell of the source secondary node being maintained. In such a configuration, the UE will keep its connection to the source SN. The required data forwarding between the nodes is thereby reduced while having a stable connection to the source SN.

The assistance information may additionally or alternatively comprise a primary secondary cell selection condition. The UE may then be configured to select a CHO configuration with a primary secondary cell fulfilling the primary secondary cell selection condition. For example, the primary secondary cell selection condition may comprise a threshold for cell quality and/or any selection conditions based on RSRP, RSRQ or SINR conditions.

The assistance information may additionally or alternatively comprise information about which information is coded in which CHO configuration. For example, the assistance information may comprise a single-dual connectivity indicator indicating which type of CHO configuration is coded in a respective CHO configuration. In another additional or alternative example, the assistance information may comprise an identifier of a primary secondary cell indicating which primary secondary cell is coded in a CHO configuration. In an alternative embodiment, the information about the CHO configurations may also be indicated differently, e.g., by including the information in additional fields accompanying the CHO configurations or by signaling them separately to the assistance information.

The source master node may also comprise means for performing the processes described herein. For example, the source master node may comprise means for transmitting a plurality of CHO configurations to the user equipment and means for transmitting assistance information for CHO recovery to the user equipment, wherein the assistance information is used by the user equipment for selecting a CHO configuration from the plurality of CHO configurations for CHO recovery. Means for the other herein described processes may be provided as well.

A flow chart for dual connectivity conditional handover with on-time data forwarding performed by a network node supporting a gNB-CU-CP functionality is presented in FIG. 7.

The network node supports at least one of central unit control plane (gNB-CU-CP) functionality or a layer 3 protocol of a radio access network, and is configured to support connection with a user equipment operating in dual connectivity with a primary cell of the network node and with a primary secondary cell of a source secondary node.

Starting with box 701, the network node, in particular, the gNB-CU-CP of the network node, generates a Radio Resource Control, RRC, message comprising assistance information for CHO recovery. Thereafter, the network node transmits the RRC message comprising the assistance information to the user equipment. The assistance information is used by the user equipment for selecting a CHO configuration from a plurality of CHO configurations for CHO recovery. The RRC message is transmitted via a gNB-DU to the UE. Embodiments described with respect to the source MN may also apply to the network node of FIG. 7 as will be understood by the skilled person.

An overall message flow diagram of an embodiment of dual connectivity conditional handover recovery is presented in FIG. 8. The message flow diagram depicts a UE 801, a source MN 802 with associated primary cell PCell-0, a source SN 803 with n associated primary secondary cell PSCell-0, a first target MN 804 with an associated primary cell PCell-1, a first target SN 805 with an associated primary secondary cells PCell-1 and PCell-3, and a second target MN 806 with an associated primary cell PCell-2, a second target SN 807 with an associated primary secondary cell PCell-2 acting during CHO recovery according to the disclosure.

The overall process of this example embodiment is as follows. In number 1, the UE 801 is served by PCell-0 of source MN 802 (S-MN) and PSCell-0 of source SN 803 (S-SN), i.e., the UE 801 is operating in dual connectivity. Number 2 indicates that the UE 801 is configured with 3 CHO configurations of the same target PCell-1 of T-MN1 804. These CHO configurations are referred to as Config 1a, Config 1b, and Config 1c. Config 1a comprises CHO configuration information for CHO towards PCell-1 and conditional PSCell Change (CPC) towards PSCell-1 of T-SN1 805 (MN+SN bearers, CHO-DC). Config 1b comprises CHO configuration information for CHO towards PCell-1 only (all MN bearers, CHO-SC). Config 1c comprises CHO configuration information for CHO towards PCell-1 and CPC towards PSCell-3 of T-SN1 805 (MN+SN bearers, CHO-DC).

In addition to those three configurations towards PCell-1, UE 801 is configured with another CHO-DC configuration towards PCell-2 of T-MN2 806 along with the CPC configuration towards PSCell-2 of T-SN2 807. This is highlighted in the box with number 3. Configurations provided to the UE 801 in numbers 2 and 3 can be provided also in a single step (using a single RRC Reconfiguration).

Number 4 depicts that the serving PCell-0 provides the assistance information to UE 801 for CHO recovery procedure as described with respect to the embodiments disclosed herein. In this example, the assistance information is considered to comprise an SC/DC prioritization flag to configure UE 801's recovery behavior and indicate which type of configurations to be prioritized during CHO recovery procedure. The assistance information is further considered to comprise an PSCell selection condition for CHO recovery procedure, which may be based on any one or all of RSRP, RSRQ or SINR measurements. Furthermore, the assistance information also comprises an indication relating to CHO-DC or CHO-SC so that the UE 801 can identify whether a configuration includes a PSCell or not such that the UE can determine which configurations to be considered/decoded during CHO recovery procedure. Moreover, the assistance information also comprises the ID of the PSCell outside of the CHO-DC configuration that is configured with PSCell ID so that the UE 801 can select/decode the desired configuration. As will be understood by the skilled person, the assistance information may also comprise a part of this information as required.

In number 5, UE 801 experiences either radio link failure on source PCell-0 and/or handover failure during CHO execution towards the originally selected target PCell-2. We assume in this example, that the UE 801 experiences a handover failure of PCell-2. Thereafter, the UE 801 selects one suitable cell for recovery, e.g., PCell-1. Suitable means that, e.g., measurements show that the radio conditions of this cell are sufficient for stable connections or any other conditions for establishing connections are met. In summary, PCell-1 is one of the prepared cells for CHO and suitable for recovering the connection.

According to the assistance information, the UE 801 prioritizes—shown in number 7—DC configurations over SC configurations as it was configured by the serving PCell-0 in number 4. The UE 801 then detects in number 8 the CHO-DC configurations that are associated with the PCell-1 by using the SC/DC indicator provided in number 4. UE 801 identifies that the Config 1a and Config 1c are the CHO-DC configurations associated with PCell-1.

In number 9, the UE 801 identifies that the PSCell-1 and PSCell-3 are the target SNs' PSCells that are configured along with the PCell-1's CHO configurations by using the assistance information provided in number 4. In number 10, the UE 801 selects one of the CHO-DC configurations associated with PCell-1, i.e., one of Config 1a and Config 1c. The selection criterion is based on the PSCell selection condition that is provided in number 4. In this example, the PSCell-3 satisfies the selection condition during recovery and the UE 801 selects the Config 1c that is associated with PSCell-3.

Afterwards and shown in number 11, the UE 801 decodes Config 1c that was selected as suitable configuration based on the assistance information in number 4 and used among numbers 7 to 11. In the final number 12, the UE 801 recovers on PCell-1 and PSCell-3 using the CHO configuration Config 1c that was selected in step 10 and decoded in step 11. As it is explained above, the UE 801 is provided and configured with sufficient information to minimize the interruption time on the SCG bearers during the recovery procedure in CHO-DC scenario.

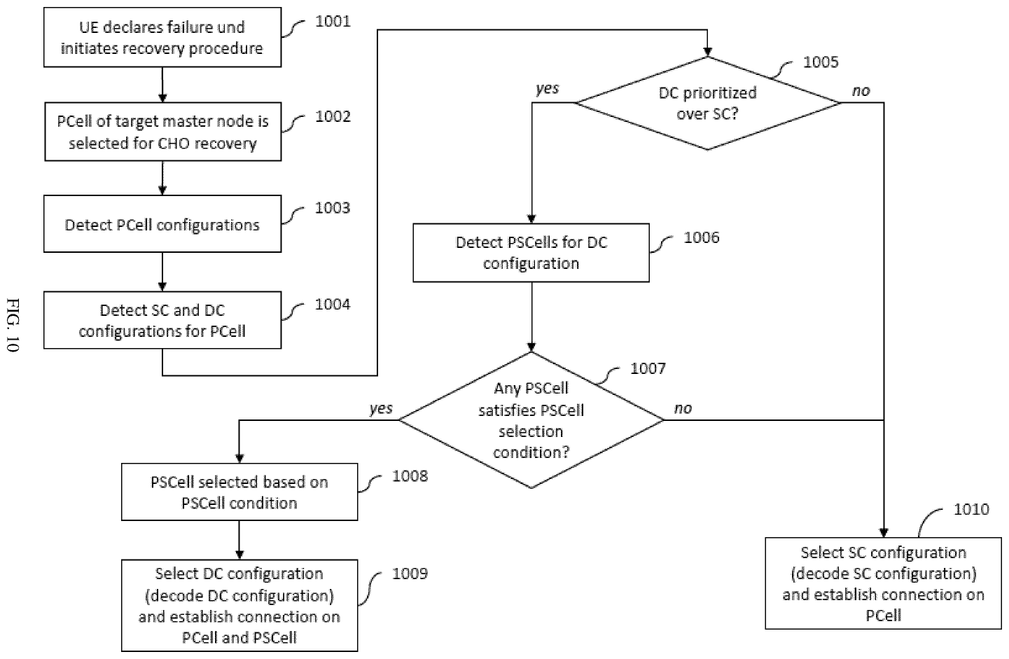

An overall message flow diagram of an embodiment of dual connectivity conditional handover recovery is presented in FIG. 9. The message flow diagram depicts a UE 901, a source MN 902 with associated primary cell PCell-0, a source SN 903 with n associated primary secondary cell PSCell-0, a first target MN 904 with an associated primary cell PCell-1, a first target SN 905 with an associated primary secondary cells PCell-1 and PCell-3, and a second target MN 906 with an associated primary cell PCell-2, a second target SN 907 with an associated primary secondary cell PCell-2 acting during CHO recovery according to the disclosure.

The overall process of this example embodiment is as follows. In number 1, the UE 901 is served by PCell-0 of source MN 902 (S-MN) and PSCell-0 of source SN 903 (S-SN), i.e., the UE 901 is operating in dual connectivity. Number 2 indicates that the UE 901 is configured with 3 CHO configurations of the same target PCell-1 of T-MN1 904. These CHO configurations are referred to as Config 1a, Config 1b, and Config 1c. Config 1a comprises CHO configuration information for CHO towards PCell-1 and conditional PSCell Change (CPC) towards PSCell-1 of T-SN1 905 (MN+SN bearers, CHO-DC). Config 1b comprises CHO configuration information for CHO towards PCell-1 only (all MN bearers, CHO-SC). Config 1c comprises CHO configuration information for CHO towards PCell-1 and CPC towards PSCell-3 of T-SN1 905 (MN+SN bearers, CHO-DC).

In addition to those three configurations towards PCell-1, UE 901 is configured with another CHO-DC configuration towards PCell-2 of T-MN2 906 along with the CPC configuration towards PSCell-2 of T-SN2 907. This is highlighted in the box with number 3. Configurations provided to the UE 901 in numbers 2 and 3 can be provided also in a single step (using a single RRC Reconfiguration).

Number 4 depicts that the serving PCell-0 provides the assistance information to UE 901 for CHO recovery procedure as described with respect to the embodiments disclosed herein. In this example, the assistance information is considered to comprise an SC/DC prioritization flag to configure UE 901's recovery behavior and indicate which type of configurations to be prioritized during CHO recovery procedure. The assistance information is further considered to comprise an PSCell selection condition for CHO recovery procedure, which may be based on any one or all of RSRP, RSRQ or SINR measurements. Furthermore, the assistance information also comprises an indication relating to CHO-DC or CHO-SC so that the UE 901 can identify whether a configuration includes a PSCell or not such that the UE can determine which configurations to be considered/decoded during CHO recovery procedure. Moreover, the assistance information also comprises the ID of the PSCell outside of the CHO-DC configuration that is configured with PSCell ID so that the UE 901 can select/decode the desired configuration. As will be understood by the skilled person, the assistance information may also comprise a part of this information as required.

In number 5, UE 901 experiences either radio link failure on source PCell-0 and/or handover failure during CHO execution towards the originally selected target PCell-2. We assume in this example, that the UE 901 experiences a handover failure of PCell-2. Thereafter, the UE 901 selects one suitable cell for recovery, e.g., PCell-1. Suitable means that, e.g., measurements show that the radio conditions of this cell are sufficient for stable connections or any other conditions for establishing connections are met. In summary, PCell-1 is one of the prepared cells for CHO and suitable for recovering the connection.

According to the assistance information, the UE 901 prioritizes—shown in number 7—DC configurations over SC configurations as it was configured by the serving PCell-0 in number 4. The UE 901 then detects in number 8 the CHO-DC configurations that are associated with the PCell-1 by using the SC/DC indicator provided in number 4. UE 901 identifies that the Config 1a and Config 1c are the CHO-DC configurations associated with PCell-1.

In number 9, the UE 901 identifies that the PSCell-1 and PSCell-3 are the target SNs' PSCells that are configured along with the PCell-1's CHO configurations by using the assistance information provided in number 4. In number 10, the UE 901 selects none of the CHO-DC configurations associated with PCell-1, i.e., neither Config 1a nor Config 1c, since the none of those satisfies the PSCell selection condition.

Afterwards and shown in number 11, the UE 901 selects the CHO-SC configuration Config 1b as suitable configuration based on the assistance information provided in number 4 and used among numbers 7 to 11. Since there is a CHO-SC configuration available for the PCell-1, UE falls back from CHO-DC recovery to CHO-SC recovery. In the number 12, the UE 901 recovers on PCell-1 by using the CHO-SC config, i.e., Config 1b.

Finally, after the successful CHO recovery procedure, the UE 901 reports to T-MN1 904 that none of the PSCells that were configured in CHO-DC configurations were suitable for CHO recovery procedure. In one embodiment, the UE 901 also reports the measurements related to PSCell-1 and PSCell-3 that were identified as PSCells associated with CHO-DC configs of PCell-1, which may be used for root-cause analysis. In another embodiment, the UE 901 reports all available measurements that can be used by the network for root-cause analysis.

FIG. 10 finally presents a flow chart of an embodiment for overall dual connectivity conditional handover recovery showing the decision mechanism that the UE may follow.

Starting with box 1001, the UE determines (and declares for itself) a radio quality failure, e.g., RLF or HOF as explained with respect to the embodiments described herein. Thereafter and shown in box 1002, a PCell of a target master node is selected for CHO recovery, e.g., based on current measurements. PCell configurations, i.e., CHO configurations for this PCell are available and detected in box 1003. These CHO configurations are categorized in those for SC and DC according to information sent with assistance information as described above. If the assistance information indicates that DC is prioritized over SC (shown in box 1005), the UE proceeds to box 1006. If not, the UE proceeds to box 1010 (as described below).

In box 1006, the UE detects the PSCells for the respective DC configurations. This may be also done according to information sent with the assistance information as described above. If then any PSCell satisfies the PSCell selection condition (shown in box 1007), the UE proceeds to box 1008. If not, the UE proceeds to box 1010 (as described below). The PSCell selection condition may be one of the conditions described above for the other embodiments, e.g., the embodiment of FIG. 5. In box 1008, the UE selects a PSCell based on a PSCell condition, e.g., the PSCell for which the best conditions were determined. The PSCell condition may also be comprised in the PSCell selection condition. If only one PSCell fulfills the selection condition, the process of box 1008 may be skipped.

Finally, the UE either selects the corresponding DC configuration in box 1009 and establishes a connection on the respective PCell and PSCell or selects the corresponding SC configuration in box 1010 and established a connection only on the respective PCell.

It should be understood that the apparatuses described herein may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE and 5G NR, similar principles can be applied in relation to other networks and communication systems where enforcing fast connection re-establishment is required. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes exemplary embodiments, there are several variations and modifications which may be made to the disclosed solution without departing from the scope of the subject disclosure.

In general, the various exemplary embodiments may be implemented in hardware or special purpose circuits, software, logic or any combination thereof. Some aspects of the subject disclosure may be implemented in hardware, while other aspects may be implemented in firmware or software which may be executed by a controller, microprocessor or other computing device, although the subject disclosure is not limited thereto. While various aspects of the subject disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Example embodiments of the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Example embodiments of the subject disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of the subject disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of the subject disclosure as defined in the appended claims. Indeed, there is a further embodiment comprising a combination of one or more embodiments with any of the other embodiments previously discussed.

1-45. (canceled)

46. A user equipment configured to support operating in dual connectivity with a primary cell of a source master node of a radio access network and a primary secondary cell of a source secondary node and configured to support conditional handover, CHO, the user equipment comprising:
at least one processor, and
at least one memory including computer program code causing the user equipment, when executed with the at least one processor, to:
establish a connection towards a primary cell of the source master node;
establish a connection towards a primary secondary cell of the source secondary node;
receive a plurality of CHO configurations from the source master node including configurations for conditional handover towards at least one target master node and at least one target secondary node;
receive assistance information for CHO recovery from the source master node;
in response to the user equipment experiencing radio link failure on the primary cell of the source master node or handover failure towards a primary cell of a first target master node, determine a primary cell of a second target master node and an associated CHO configuration from the plurality of CHO configurations based on the assistance information for CHO recovery; and
perform CHO recovery towards the primary cell of the second target master node based on the determined associated CHO configuration.

47. The user equipment of claim 46 further being caused to, in response to the determined CHO configuration being a dual connectivity CHO configuration with a primary secondary cell of a target secondary node being different to a primary secondary cell of the source secondary node, perform CHO recovery towards the primary secondary cell of the target secondary node.

48. The user equipment of claim 46, wherein the assistance information comprises a single-dual connectivity prioritization flag for prioritizing single or dual connectivity for CHO recovery.

49. The user equipment of claim 46, wherein the assistance information comprises information on pending traffic volumes on secondary cell group bearers, wherein determining the CHO configuration comprises prioritizing a single connectivity CHO configuration in response to the single connectivity CHO configuration having secondary cell group bearers mapped to a respective target master node, and prioritizing a dual connectivity CHO configuration in response to the dual connectivity CHO configuration having the secondary cell group bearers mapped to a respective target secondary node.

50. The user equipment of claim 46, wherein the assistance information indicates to prioritize a dual connectivity CHO configuration with the primary secondary cell of the source secondary node being maintained.

51. The user equipment of claim 46, wherein the assistance information comprises a CHO recovery primary secondary cell selection condition, wherein determining the CHO configuration comprises selecting a CHO configuration with a primary secondary cell fulfilling the primary secondary cell selection condition.

52. The user equipment of claim 51, wherein determining a CHO configuration comprises selecting a single connectivity CHO configuration in response to none of at least one primary secondary cell fulfilling the primary secondary cell selection condition.

53. The user equipment of claim 52, wherein the user equipment is further caused to:
a. in response to selecting a single connectivity CHO configuration with the second target master node, transmit cell selection information to the second target master node comprising an indication that none of the at least one primary secondary cell associated with the second target master node fulfilling the primary secondary cell selection condition.

54. The user equipment of claim 53, wherein the cell selection information further comprises measurements related to the at least one primary secondary cell associated with the second target master node.

55. The user equipment of claim 53, wherein the cell selection information further comprises measurements related to further cells performed at the user equipment.

56. The user equipment of claim 46, wherein the assistance information comprises a single-dual connectivity indicator indicating whether a respective CHO configuration is a single or dual connectivity configuration.

57. The user equipment of claim 46, wherein the assistance information comprises an identifier of a primary secondary cell indicating which primary secondary cell is included in a respective CHO configuration.

58. A source master node configured to support establishing connection towards a user equipment configured to support operating in dual connectivity with a primary cell of the source master node and with a primary secondary cell of a source secondary node and supporting conditional handover, CHO, comprising:
at least one processor, and
at least one memory including computer program code causing the source master node,
when executed with the at least one processor, to:
a. transmit a plurality of CHO configurations to the user equipment including configurations for conditional handover towards at least one target master node and at least one target secondary node; and
b. transmit assistance information for CHO recovery to the user equipment, wherein the assistance information is used by the user equipment for determining a CHO configuration from the plurality of CHO configurations for CHO recovery.

59. The source master node of claim 58, wherein the assistance information comprises a single-dual connectivity prioritization flag for prioritizing single or dual connectivity for CHO recovery.

60. The source master node of claim 59, wherein the single-dual connectivity prioritization flag is determined based on pending traffic volumes on secondary cell group bearers for prioritizing a single connectivity CHO configuration in response to the single connectivity CHO configuration having secondary cell group bearers mapped to a respective target master node, and prioritizing a dual connectivity CHO configuration in response to the dual connectivity CHO configuration having the secondary cell group bearers mapped to a respective target secondary node.

61. The source master node of claim 58, wherein the assistance information indicates to prioritize a dual connectivity CHO configuration with the primary secondary cell of the source secondary node being maintained.

62. The source master node of claim 58, wherein the assistance information comprises a CHO recovery primary secondary cell selection condition for determining a CHO configuration with a primary secondary cell fulfilling the primary secondary cell selection condition.

63. The source master node of claim 58, wherein the assistance information comprises a single-dual connectivity indicator indicating whether a respective CHO configuration is a single or dual connectivity configuration.

64. The source master node of claim 58, wherein the assistance information comprises an identifier of a primary secondary cell indicating which primary secondary cell is included in a respective CHO configuration.

65. A network node that supports at least one of central unit control plane functionality or a layer 3 protocol of a radio access network, configured to support connection with a user equipment operating in dual connectivity with a primary cell of the network node and with a primary secondary cell of a source secondary node, and configured for conditional handover, CHO, the network node comprising:
at least one processor, and
at least one memory including computer program code causing the network node, when executed with the at least one processor, to:
a. generate a Radio Resource Control, RRC, message comprising assistance information for CHO recovery; and
b. transmit the RRC message comprising the assistance information to the user equipment, wherein the assistance information is used by the user equipment for determining a CHO configuration from a plurality of CHO configurations including configurations for conditional handover towards at least one target master node and at least one target secondary node for CHO recovery.

66. The network node of claim 65, wherein the assistance information comprises a single-dual connectivity prioritization flag for prioritizing single or dual connectivity for CHO recovery.

67. The network node of claim 66, wherein the single-dual connectivity prioritization flag is determined based on pending traffic volumes on secondary cell group bearers for prioritizing a single connectivity CHO configuration in response to the single connectivity CHO configuration having secondary cell group bearers mapped to a respective target master node, and prioritizing a dual connectivity CHO configuration in response to the dual connectivity CHO configuration having the secondary cell group bearers mapped to a respective target secondary node.

68. The network node of claim 65, wherein the assistance information indicates to prioritize a dual connectivity CHO configuration with the primary secondary cell of the source secondary node being maintained.

69. The network node of claim 65, wherein the assistance information comprises a CHO recovery primary secondary cell selection condition for determining a CHO configuration with a primary secondary cell fulfilling the primary secondary cell selection condition.

70. The network node of claim 65, wherein the assistance information comprises a single-dual connectivity indicator indicating whether a respective CHO configuration is a single or dual connectivity configuration.
